(19) United States
(12) Patent Application Publication
(10) Pub. No.: US 2020/0167258 A1
(43) Pub. Date: May 28, 2020

(54) RESOURCE ALLOCATION BASED ON APPLICABLE SERVICE LEVEL AGREEMENT

(71) Applicant: Intel Corporation, Santa Clara, CA (US)

(72) Inventors: Rita CHATTOPADHYAY, Chandler, AZ (US); Uri ELZUR, San Jose, CA (US)

(21) Appl. No.: 16/775,069

(22) Filed: Jan. 28, 2020

(51) Int. Cl. G06F 11/34; G06F 9/50; G06N 20/00

(52) U.S. Cl. CPC G06F 11/3433; G06N 20/00; G06F 9/5011

(57) ABSTRACT

Examples described herein provide for a memory and at least one processor coupled to the memory. The at least one processor indicates a prediction of a performance goal failure based on performance monitoring of the at least one processor. The performance goal can be based on a service level agreement (SLA). The performance monitoring can be related to core activity or inactivity. A trained machine learning (ML) model can be used to infer performance goal failure based on performance monitoring of the at least one processor. The ML model can be trained using a simulation of traffic to use a compact set of performance monitoring indicators. Mitigation efforts can take place to avoid violation of the SLA.

In data center environments, ensuring Key Performance Indicators (KPIs) of an application are met, is a challenging problem. Multiple different applications or virtual machines or containers running on different central processing unit (CPU) cores can have different consumption patterns of platform resources (e.g., compute, accelerator, cache, memory, storage, or networking). Shared infrastructure (e.g., server platform) for multiple workloads with potentially different service level agreements (SLAs) and resource utilization and dynamically varying loads, further aggravates the challenge of meeting KPIs.

Application performance can deteriorate due to multiple reasons. Some of the reasons include: scarcity of resources due to other competing workloads, overloading the platform, a change in the volume of the workload to be processed by the application as opposed to available resources, hardware or software failure, misconfiguration and/or delayed response from a gating collaborating application (or application element).

### BRIEF DESCRIPTION OF THE DRAWINGS

FIG. 1A depicts an example system.

FIG. 1B depicts an example sequence to detect conditions that are present prior to or during a packet drop.

FIG. 2A depicts an example scenario of training a model where cores run a particular software environment.

FIG. 2B depicts an example manner of detecting for packet drop.

FIG. 3 depicts an example of a manner of processing performance indicators.

FIG. 4 presents preprocessed and synchronized system and network activity data.

FIG. 5 shows the packet drop ground truth collected from a traffic generator.

FIG. 6 presents example results of a trained ML inference model.

FIG. 7 shows a True Positive Rate (TPR) and False Positive Rate (FPR) with respect to the number of features used, ranked as per their correlation to packet drop.

FIG. 8 shows an example of parameters used to predict downlink (DL) packet drop.

FIG. 9 depicts an example process.

FIG. 10 depicts a system.

FIG. 11 depicts an example environment.

### DETAILED DESCRIPTION

Packet delay or jitter or even loss occurs when one or more packets of data travelling across a computer network take longer thereby creating a wide distribution on the time axis as to the network travel time. These phenomena of packet delay, jitter, or loss may be caused by multiple factors. The most common, complex and critical is that of network congestion due to overrun of network switch buffers. Other reasons may include, physical layer issues such as wire quality, cyclic redundancy check (CRC) errors, loss of connectivity, errors in data transmission, or NIC issues.

Packet loss at a server can occur when one or more packets are dropped by the network interface controller (NIC), virtual switch (vSwitch) (e.g., software that enables communication between virtual machines) or a virtual machine or container. This packet loss may be caused by multiple factors, e.g., lack of compute resource to process it, memory resources, network policy (either getting the right policy or configuration or execution error).

Packet delay, jitter, and loss reduce throughput for a given sender and or a given network flow. For example, network congestion leading to packet delays, jitter or drops may cause the application to wait or halt for re-transmissions of those packets. However, not all flows are equal and the significance to application's performance from a given packet loss, may vastly vary. Short synchronization messages common in hyperscale datacenter (DC) and/or cloud applications are especially prone to it.

When a drop is imminent, to decide which packet to drop and which to make best effort or guarantee transport particularly, many switches use first in first out (FIFO) queues or statically set priorities (e.g., IEEE 802.1 Class of Service signaling or Internet Protocol (IP) level Differentiated Services Code Point (DSCP)). Hence a global network state or the packet situation in the network (e.g., Least Slack Time First algorithms that require headers not readily available) as well as the application state and sensitivity to drop may not be considered.

On the compute platform (e.g., processors, memory, and interfaces), however, an operating system scheduler may provide scheduling priority to those programs closer to completion, but may fail to see the interaction of distributed application elements and its impact on the global end-to-end application performance.

Another consideration absent from network scheduling and resource allocations is the application value to the data center owner and/or the Service Level Agreement (SLA) attached to that application (e.g., for finishing up a computation, providing network service to a consumer, or real time experience to a user). The application status and particularly how close to violating its SLA or whether the applicant's SLA has already violated are not considered. For example, SLA requirements may include one or more of: response time, refresh rate of displayed video frame, maximum packet drop percentage, application availability (e.g., 99.999% during workdays and 99.9% for evenings or weekends), maximum permitted response times to queries or other invocations, requirements of actual physical location of stored data, or encryption or security requirements.

Algorithms to decide the best location for a storage infrastructure element are many times based on partial and/or local data. For example, the ability of a given storage element to sustain the combined demand of all workloads sharing it or the ability of the supporting network to deal with the combined network demand and still provide a short tail (e.g., controlled jitter) is rarely considered. As a result, hot spot or cases of excessive or undetermined delay may occur, negatively affecting application and infrastructure efficiencies. Each network element (or device or box) may be provided by different vendor and their internals are unknown.

On the compute node, the challenge is to balance the aforementioned resources to achieve the highest number of co-resident workloads while achieving the SLA as higher workload density reduce total cost of ownership. Fingerprinting an application to know its resource utilization pattern can be used to determine resource allocation but not only is such an approach time consuming, it requires advance knowledge of resource utilization patterns and needs to be repeated anytime one parameter is changed. Fingerprinting can lead to conservative allocation per the worst utilization levels, which lowers workload densities.

Another approach is to collect telemetry, such as creating a data lake (also known as BigData), submit it to a Machine Learning algorithm to sort through the signals to find those that carry the relevant and vital information and then, adjust the placement and/or the resource allocation of some workloads. However, algorithms for monitoring the application KPIs are generally based on a large number of telemetry data collected from different sources and these algorithms often add compute overhead to the already constrained compute infrastructure. In addition, there can be delay that makes it challenging to react in real time and fast enough to avoid SLA violation.

Hence it is important for the data center owners and operators, broader network owners and operators, application/system developers, and/or network providers to be able to prioritize relevant network traffic to prevent packet delay, jitter, or drops and balance placement and resource allocation to meet SLAs while reducing total cost of ownership (TCO) by providing higher workload density on the infrastructure as opposed to underutilizing resources to meet SLAs.

Some solutions focus on a single component and enable reactive response to events like a packet drop in the network fabric (e.g., switches and routers). The solutions rely on performance and telemetry data from the network fabric, such as switches and routers, to provide reactive responses. Many of these devices do not provide any insight into critical aspects of their real time behavior (e.g., flow competition for switch buffer resources) and do not allow ability to accurately schedule and prioritize network flows in concert with data center owner priorities.

Various embodiments provide prediction of SLA violation before the application or system performance fails an SLA and the failure prediction will indicate the imminent issue to the orchestration layer. According to some embodiments, an ML model can be used to infer packet drop from particular values of particular KPIs. According to some embodiments, prediction of failure of a performance goal occurs independent from measurement of the performance and based on performance monitoring of the at least one processor using a compact set of measurements. For example, prediction of failure of a performance goal independent from measurement of the performance can include not measuring the performance level. For example, prediction of a particular packet drop rate occurring can take place without measuring the packet drop rate but measuring other parameters.

The orchestration layer will be able to perform mitigating actions to prevent the SLA deviation. Various embodiments monitor real time behavior of network devices without direct detailed telemetry related to buffer allocation per flow of packets, using the contextual telemetry collected from various elements used by a flow of packets. Machine-learning (ML) can be used to infer likely occurrences of packet drops or violations of SLAs.

Various embodiments provide ML-based technology to detect or predict application performance in which potential SLA violation will occur along with application policy violation based on CPU and/or platform performance metrics. Various embodiments predict an application failing its SLA by taking into account multiple but compact set of KPIs. KPIs can include for example response of the workload on server, network subsystem performance such as packet drop or delay on the server or network device as well as storage subsystem latency or congestion, telemetry from multiple elements of the end-to-end solution among a server platform, network, storage subsystem and so forth. For example, scheduling resources of a server end point (e.g., network interface or vSwitch) and the network elements (e.g., switch, router) can be based on performance of the server end point and network elements to avoid violation of one or more applicable SLAs but using a limited set of data to limit computation resources used to determine imminent violation of one or more applicable SLAs.

According to various embodiments, a limited or small set of key CPU or platform telemetry parameters are identified that provide high quality (e.g., low false positive and false negative) indication of existing or imminent SLA failure. SLA failure indication are provided to an orchestration layer (or other entity) (e.g., OpenStack or Kubernetes) to relocate a workload before an SLA violation has been detected. Key CPU/platform telemetry signals can be based on a pre-learned ML model trained on the key parameters with a set of representative workloads. The ML model can be further optimized for higher accuracy when trained on a given workload or application for which SLA failure is to be predicted.

Various embodiments monitor application performance based on workload responsiveness and network interaction based on compute system telemetry data with the network devices telemetry data and with storage elements and other elements as necessary (e.g., graphics processing unit (GPU), field programmable gate array (FPGA) and so forth). Various embodiments monitor data and/or telemetry collected from the infrastructure, the application, the orchestration, management entities and/or operator. Based on application performance, monitored data, and telemetry, allocation of compute nodes, storage nodes, accelerators, or network devices can be allocated, configured, prioritized, or scheduled to adjust network behavior and flow completion times (FCT) to achieve applicable SLAs.

Various embodiments attempt to detect packet delay, jitter, or drop can be detected at the earliest time and take mitigating actions (e.g., adjusting network scheduling, adjusting resource allocation, adjusting priorities, and/or path selection) to address cause of packet delay, jitter, or drop and adapt it to the business goals (e.g., SLA requirements) of all the traffic running in the data center at that time. Various embodiments gain visibility into the way a network device has allocated resources and detect and analyze which packets/flows have been competing for a given resource (e.g., an output queue) so that a better scheduling scheme or other mitigation/planning can be devised.

Various embodiments can allocate compute resources to prevent violating an SLA attached to an application (e.g., for providing network service to a consumer, or real time experience to a user etc.). Embodiments described herein can be applied to adjust resource allocation based on predicted SLA violation of any compute, accelerator, cache, memory, storage, or networking resource. Infrastructure elements such as CPUs, network interfaces, storage, accelerators, FPGA, GPU can be configured for a given workload to avoid SLA violation.

Various embodiments can modify network flow scheduling based on indications available in the application span of infrastructure. For example, host and server CPU parameters, network subsystem on the server, external network device and storage subsystem (e.g., erasure codes or storage device/media based). Various embodiments provide network flow scheduling to avoid congestion, packet drops and the subsequent increase in latency and SLA violation.

Various embodiments can be used in a CPU, offload engine, accelerator, or other device or processor-executed software to monitor, detect and predict SLA deviation in near real time based on key CPU and platform parameters. Machine learning inference engine micro-code that predict SLA violation can be implemented in CPUs, network interface devices, storage cards, memory pools, or other hardware or software or accelerators on FPGAs or as machine learning based co-processors used for detecting network anomalies.

Various embodiments can predict SLA failure and accordingly, pre-testing application coexistence may not be needed to determine resource allocation that does not violate an SLA. Dynamic interactions of multiple workloads in a given infrastructure can lead to conservative and lower utilization levels and higher TCO. But various embodiments permit data center service provider to not undersubscribe resources due to pessimism that SLA will not be met at least for dynamic interactions of multiple workloads.

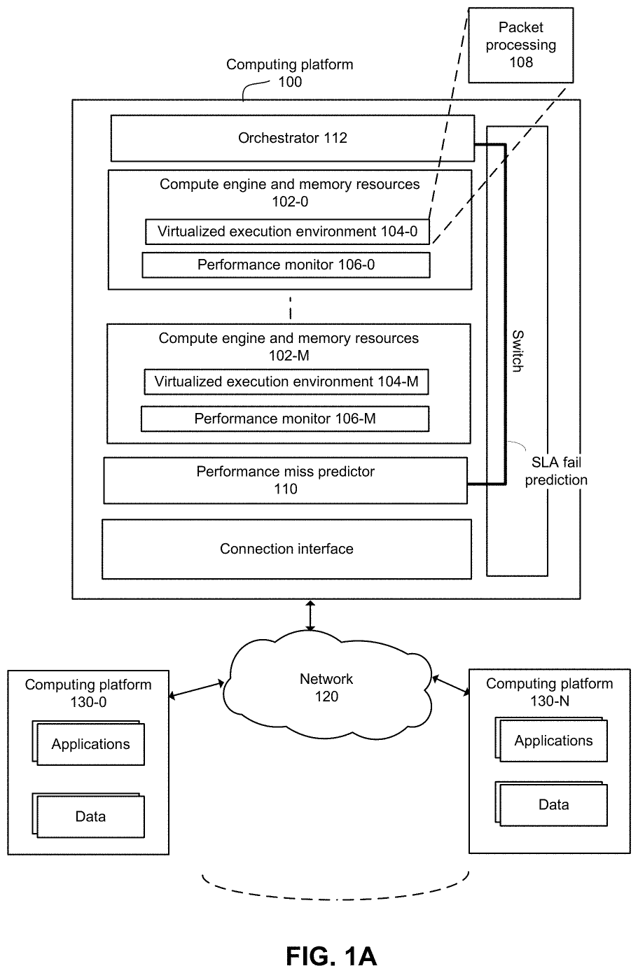

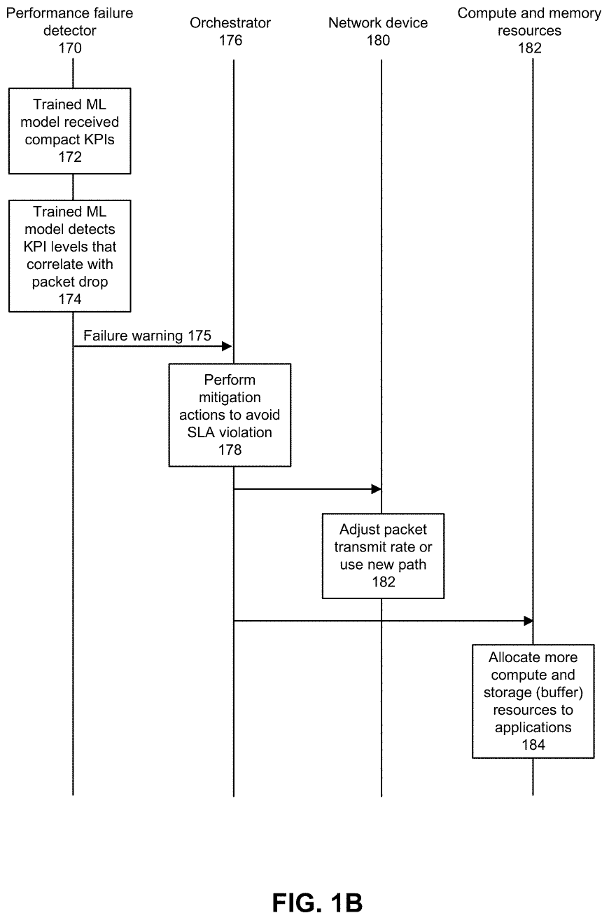

FIG. 1A depicts an example system. According to some embodiments, computing platform 100 generates a global understanding of workloads running in computing platform 100 and their interaction profiles with infrastructure elements in which packet drops occur. Computing platform 100 can include or access compute engine and memory resources 102-0 to 102-M, where M is an integer of 1 or more. As used herein, compute engine and memory resources 102 can refer to any or all of compute engine and memory resources 102-0 to 102-M. Compute engine and memory resources 102 can include any a combination of a: processor, core, graphics processing unit (GPU), field programmable gate array (FPGA), application specific integrated circuit (ASIC), or other programmable hardware device, as well as memory devices, storage devices, and interfaces.

Compute engine and memory resources 102 can run virtualized execution environment 104. As used herein, virtualized execution environment 104 can refer to one or more of virtualized execution environments 104-0 to 104-M. A virtualized execution environment can include at least a virtual machine or a container. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can be an OS or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from each other, allowing virtual machines to run Linux® and Windows® Server operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers are not installed like traditional software programs, which allows them to be isolated from the other software and the operating system itself. Isolation can include permitted access of a region of addressable memory or storage by a particular container but not another container. The isolated nature of containers provides several benefits. First, the software in a container will run the same in different environments. For example, a container that includes PHP and MySQL can run identically on both a Linux computer and a Windows® machine. Second, containers provide added security since the software will not affect the host operating system. While an installed application may alter system settings and modify resources, such as the Windows® registry, a container can only modify settings within the container.

A virtualized execution environment in some examples can run a packet processing process 108. Packet processing process 108 can perform packet processing using Network Function Virtualization (NFV), software-defined networking (SDN), virtualized network function (VNF), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. VNF can include a service chain or sequence of virtualized tasks executed on generic configurable hardware such as firewalls, domain name system (DNS), caching or network address translation (NAT) and can run in virtual execution environments. VNFs can be linked together as a service chain. In some examples, EPC is a 3GPP-specified core architectures at least for Long Term Evolution (LTE) access. 5G network slicing can provide for multiplexing of virtualized and independent logical networks on the same physical network infrastructure.

Packet processing process 108 can provide network functions and control and data plane traffic for multitudes of subscribers consuming IP Multimedia Subsystem (IMS) and other over-the-top services in 5G, LTE, Global System for Mobile Communications (GSM) compatible communications, Universal Mobile Telecommunications Service (UMTS) compatible communications, Enhanced High-Rate Packet Data (eHRPD), and IEEE 802.11.

A packet can include a formatted collections of bits that may be sent across a network, such as Ethernet frames, IP packets, TCP segments, UDP datagrams, quick UDP Internet Connections (QUIC) and so forth. Also, as used in this document, references to L2, L3, L4, and L7 layers (or layer 2, layer 3, layer 4, and layer 7) are references respectively to the second data link layer, the third network layer, the fourth transport layer, and the seventh application layer of the OSI (Open System Interconnection) layer model. A packet can include a header and payload. A header can be a media access control (MAC) source and destination addresses, Ethertype, Internet Protocol (IP) source and destination addresses, IP protocol, Transmission Control Protocol (TCP) port numbers, virtual local area network (VLAN) or Multi-Protocol Label Switching (MPLS) tags.

A packet can be associated with a flow. A flow can be one or more packets transmitted between two endpoints. A flow can be identified by a set of defined tuples, such as two tuples that identify the endpoints (e.g., source and destination addresses). For some services, flows can be identified at a finer granularity by using five or more tuples (e.g., source address, destination address, IP protocol, transport layer source port, and destination port).

In some examples, compute engine and memory resources 102 can be formed as a composable or composite node can be formed from compute (e.g., CPUs, GPUs, accelerators), networking, memory, storage, and software resources in a device or separate devices that are communicatively coupled using a bus, interconnect, fabric or network. A pod manager can assemble and provide a composable or composite node of hardware and software resources to an orchestrator (e.g., Open Network Automation Platform (ONAP) and Open Source Management and Orchestration (OSM)) and the orchestrator can instantiate the environment for the particular tenant on the composite node.

In some examples, virtualized execution environment 104 can also execute applications that provide media streaming (e.g., movies or audio), video streaming from security and surveillance cameras on public and private infrastructures (home, offices, traffic poles, and so forth), video games, graphics rendering, web queries on search engines, database queries, remote monitoring (sensor data from industrial sensors, medical sensors etc.).

Virtualized execution environment 104 can execute a performance monitor 106 to monitor performance indicators where performance monitor 106 can refer to one or more of performance monitors 106-0 to 106-M. In some examples, performance indicators are Key Performance Indicators (KPIs). In some examples, performance monitor 106 can use a collectD daemon. Examples of performance indicators include one or more of: core idle measurement, core execution of user space processes, or core waiting for an input/output operation to complete. Depending on the network architecture and load, performance monitor 106 can also monitor network bandwidth and packet latencies.

According to some embodiments, performance miss predictor 110 can use a machine learning (ML) or artificial intelligence (AI) to infer when a packet drop is to occur based on performance indicators from performance monitor 106. For example, the artificial intelligence (AI) or ML model can use or include any or a combination of: a reinforcement learning scheme, Q-learning scheme, deep-Q learning, or Asynchronous Advantage Actor-Critic (A3C), combinatorial neural network, recurrent combinatorial neural network, and so forth. Performance miss predictor 110 can predict SLA failure based on network packet-loss or congestion based on key parameters and predicted failure to an external system such as orchestrator 112.

Training of the ML model could be conducted prior to deployment where simulated workloads using software and hardware environments can generate inferences to predict packet drop using a limited group of KPIs in accordance with embodiments described herein. ML training can use a compacted set of telemetry signals to identify the most correlated CPU and/or platform parameters and key application KPI influencing an individual workload SLA adherence or failure. ML training can occur by testing against sets of workloads, until no new KPI signals are needed when a new workload is tested against the trained ML model with acceptable levels of false positives and false negatives. Accordingly, a compact set of parameters can be the parameters where saturation detection of accuracy occurs (leveling off) as compared to use of more parameters.

Performance miss predictor 110 can be implemented as processor-executed software, a component of a CPU, a component of a network interface, a component of a switch and/or a component of a storage or memory product. Performance miss predictor 110 can be embedded as machine learning inference engine micro-code in CPUs, accelerators on FPGAs or as machine learning based co-processors.

Performance miss predictor 110 can operate in Application Agnostic (AA) and Application Specific (AS) modes. In the AA mode, a small set of telemetry signal is identified that is good enough to detect and predict the health of an application regardless of the application type while ensuring sufficiently high accuracy of false positives and false negatives. For AA mode, the effort to test all applications for their respective resource requirements, noisy neighbor sensitivities/behavior and network interference patterns are not needed. To achieve even higher accuracy level, an AS mode where the inference algorithm is specifically trained and tailored to a given application can be created as well.

In some examples, orchestrator 112 can perform corrective actions based on indication of packet drop from drop prediction. For example, orchestrator 112 can modify performance at an application level to affect data transmission scheduling and/or transmission in a way that is application aware or unaware), to migrate compute activity (virtualized execution environment or application), in order to reduce or eliminate a “noisy neighbor,” “blast radius,” and/or control network data traffic, to reduce congestion and avoid packet drops. Congestion can increase latencies and/or storage network or device activity.

In some examples, based on prediction of an SLA violation from performance miss predictor 110, to control the network data traffic, so as to avoid congestion and avoid packet drops and reduce latencies and/or storage network or device activity, orchestrator 112 can cause a network device, storage device, FPGA, and/or GPU to apply one or more of: policy or configuration change, packet source-to-destination path change, resource allocation change, and/or priority. Equal-cost multi-path (ECMP) can be used to select another path. Orchestrator 112 can attempt to modify packet buffer space allocation, packet transmission scheduling, packet transmission to more optimally distribute load on the network or the storage device. Orchestrator 112 can perform mitigation actions to reduce network congestion such as one or more of: orchestrating CPU workload to increase availability of resources, increasing CPU frequency, reconfiguring TCP/IP settings to adjust the TCP/IP settings to slow the request of packets, or use of a “choke packet.” A choke packet is used in network maintenance to prevent the congestion of a network. As a network begins to slow and become congested, a choke packet is sent to slow the output of the sending computer. Decreasing the sending rate is what will allow the receiving computer and routers to catch up. This can prevent the congestion from getting worse and leading to packet loss or a time out. By slowing requests, the receiving computer will be able to manage processing the packets. This can minimize the occurrence of congestion at the receiving computer.

In some examples, an AI or ML model used by performance miss predictor 110 can be re-trained during operation. For example, performance miss predictor 110 can determine when packet drop predictions are inaccurate based on feedback from a server or network interface that indicates whether a packet drop actually happened by providing a packet re-transmit request. Observations of correlations between computing resource activity and packet drop can be used to re-train the model to more accurately predict packet drop rates.

FIG. 1B depicts an example sequence to detect conditions that are present prior to or during a packet drop rate meeting or exceeding a threshold. A performance failure detector 170 uses a trained ML model to process a compact group of KPIs (172) to identify KPI levels (174) that correlate with packet drop or imminent packet drop at a computing node. In some examples, the ML model is trained for an application specific environment whereby for a particular set of applications running on a computing resource node with memory, a compact set of KPIs are used to identify packet drop or imminent packet drop. In some examples, the KPI levels are core idle measurement, core execution of user space processes, or core waiting for an input/output operation to complete. For example, packet drop or imminent packet drop is detected for a particular flow identifier based on packet header characteristics (e.g., flow or traffic class).

Performance failure detector 170 informs orchestrator 176 using a failure warning 175 of the packet drop or imminent packet drop for a particular one or more flows. Orchestrator 176 performs mitigation action 178 to avoid SLA violation related to packet drops for the identified one or more flows. For example, at 182, orchestrator 176 configures a transmitter network device 180 (e.g., source endpoint, router, switch) to adjust a transmit rate (e.g., lower) or use a new path for the one or more packet flows. In addition, or alternatively, orchestrator 176 configures compute and memory resources 182 that is predicted to experience packet drop to allocate more compute resources and/or buffer space for the one or more flows. For example, packets could be dropped because there are insufficient CPU or processing resources to process the packets and increasing CPU power frequency or polling rate of received packets to process packets of a particular flow can alleviate packet drop. In addition, prioritization of processing the one or more packet flows may be increased to reduce likelihood of packet drop. Allocating additional storage (buffer) for received packets can allow additional packets to be stored instead of dropped. Uplink drop can be mitigated by the client, as this data is generated by client machine.

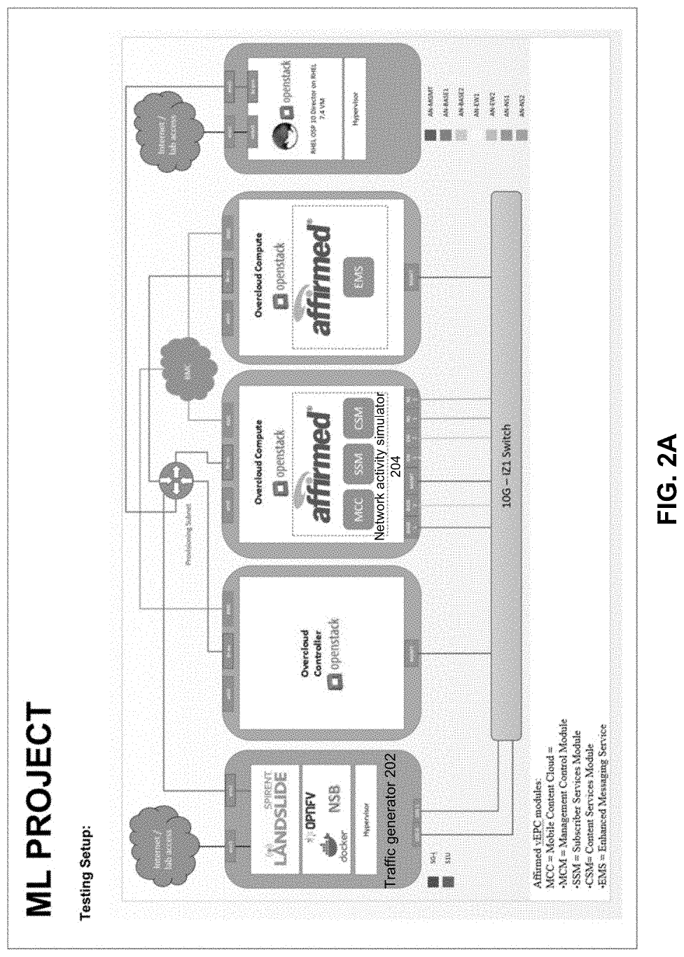

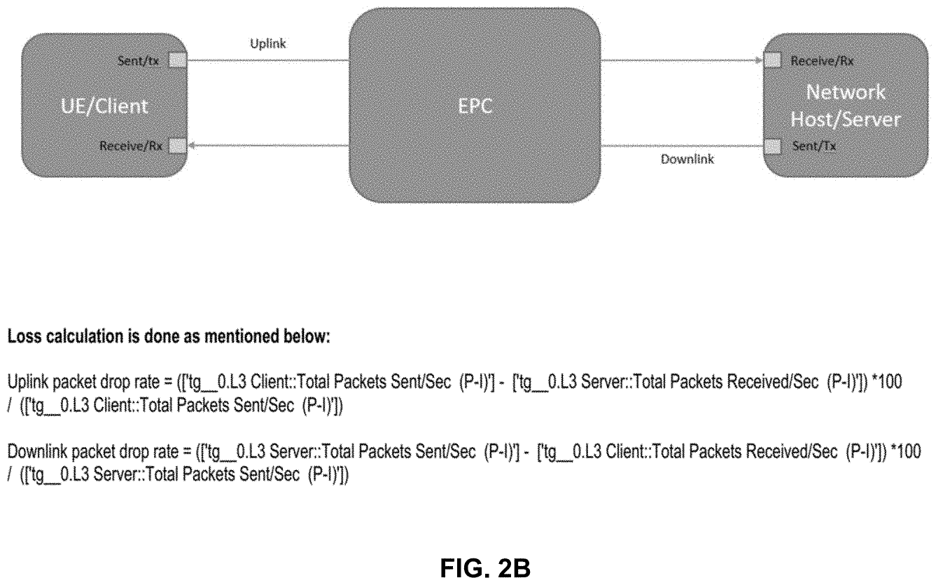

FIG. 2A depicts an example scenario of training a model where cores run a particular software environment. A traffic generator 202 can be used to simulate network traffic and generate the ground truth for packet drop. Traffic generator 202 can be a Spirent traffic generator that determines packet drop based on the number of packets sent and received by the clients (e.g., simulated 4G LTE user equipment) and server at any instance of time. The sampling rate can be 15 seconds.

Network activity can be simulated by network activity simulator 204. Network activity simulator 204 can execute Affirmed virtual Evolved Packet Controller (vEPC) to simulate network functions generally performed by discrete hardware or a packet processing engine based on application activity and/or network traffic. vEPC is a framework for virtualizing functions to converge voice and data processing on 4G Long Term Evolution networks.

For example, a particular software environment can be used to train a ML model so that the model is tailored to identify predicted packet drops for a compact set of particular key performance measurements of a system that runs a particular software configuration. An ML model can execute on a client machine or server. A server can include cores that execute a vEPC that also run one or more of: mobile content cloud (MCC), Management Control Module (MCM), subscriber services module (SSM), and content services module (CSM). MCM can control operations, administration, and management, command line interfaces (CLIs). CSM can be a VM instance that runs the tasks needed for call control, IP routing and providing advanced services like video optimization, TCP Proxy, HTTP Proxy, and so forth. SSM can be a user plane VM responsible for receiving packets into the MCC and sending the packets out and providing workflow services. In some examples, a Content Service Module (CSM) can run core content service operations such as control/subscriber management and infrastructure tasks (e.g., statistics collection, alarms, events, and so forth).

In some examples, KPI information can be collected from the compute resources that execute MCC, MCM, SSM and/or CSM. In some examples, collectD daemons run on simulator 204 that runs MCC, MCM, SSM and/or CSM. Telemetry compaction can be used for identifying the most correlated CPU/platform parameters to key KPI indicating application health (including network packet drop). A set of KPIs can provide an indication of application “health” (e.g., application response time to requests, network congestion and packet drop etc.). ML training analytic blocks can be trained based on collectD telemetry data (but could be using other broad set, as long as they rely on signals natively available in the Intel XEON products or server platforms, common operating systems, hypervisors, orchestration, network devices, storage devices, and so forth).

For application-specific results and ultimate elimination of false positive and false negatives, additional telemetry signals and ML algorithm or components may be added. Additional telemetry signals can be collected from network interface, storage, GPU, FPGA devices in the infrastructure supporting a given application.

Various embodiments can allow a setup of infrastructure operation by influencing potential placements of code, data, or network paths or by affecting scheduling or transmission times, bandwidth, priority, path of network traffic to eliminate to minimize or mitigate traffic delay, jitter, congestion or packet drops.

FIG. 2B depicts an example manner of detecting for packet drop. Uplink and downlink traffic between user equipment (UE)/client and a network host/server are simulated. The network activity can be simulated by a Virtual Evolved Packet Controller (EPC) to simulate activity performed for packet processing. Packet drops can occur while the data is transmitted from a server to a client (down link) or from a client to a server (uplink). Uplink and down link packet drop rates can be computed.

Various embodiments include a feature ranking method to rank a large number of telemetry data based on their correlation with application component health and adherence to SLA requirements. Various embodiments select just a compacted set of top telemetry signals, providing more than an order of magnitude reduction in the telemetry data that are used to predict SLA violation. Various embodiments present various CPU parameters, which can be monitored and passed through a pre-trained ML model to detect/predict network packet drops. This reduces the load on the devices generating the telemetry (e.g., server or switch), reduces the load on the network to transfer that data, prevents a BigData problem (searching for the needle in the haystack), and reduces latency in predicting SLA violation (near real time operation).

For example, example KPIs that can be collected from a CPU include the following. From a performance monitoring unit (PMU) registers: page-faults, minor-faults, cache-misses, or context-switches. Page and minor faults occur when the OS does not find a particular page (data segment) in memory. Cache misses occur when the data is not found in cache and context switches provide information as to rate at which OS switches context for CPU. From a collectD CPU_value plugin: softirq (e.g., soft interrupts), wait, idle, user. From collectD plugin load: longterm, shortterm, midterm. The longterm, shortterm, midterm represent respective average queue lengths over 1 minute (shortterm), 5 minutes (midterm) and 15 minutes (longterm).

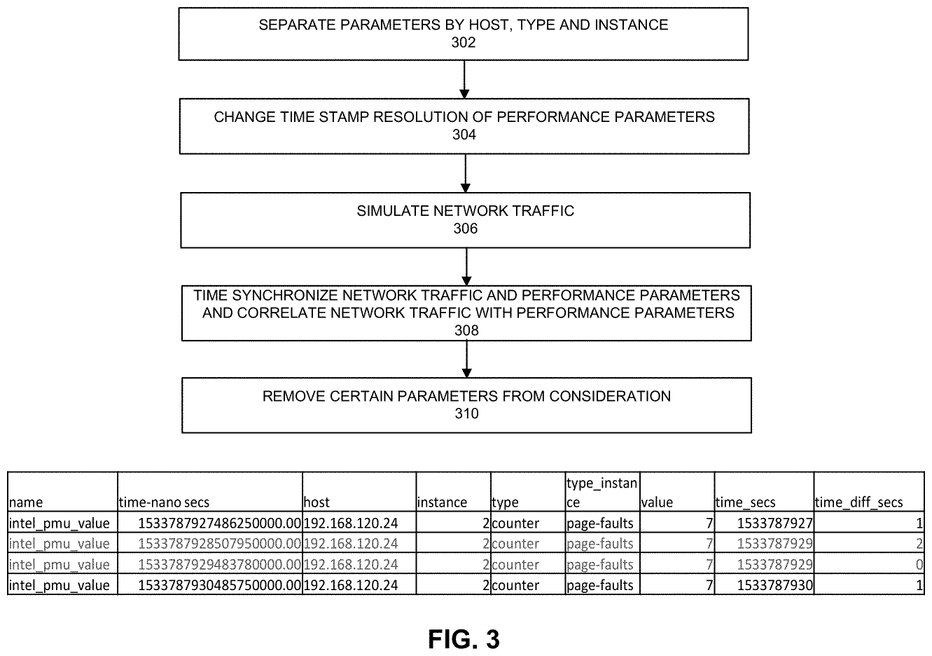

FIG. 3 depicts an example of a manner of processing performance indicators. Various embodiments use a set of data pre-processing methods to time synchronize both traffic generator data and telemetry information. For example, at 302, parameters can be separated by host, type and instance (core number). Parameters from various collectD plugin files or daemons are gathered for various host, type of telemetry (counter, rates, percentage, and so forth) and core. An example of collectD plugin files include intel_pmu_value_counter_page-faults_0, cpu_value_percent_softirq_0, and so forth. An example of parameters is shown at the bottom of FIG. 3. At 304, time stamp resolution of performance parameters is changed. The time-stamp resolution for performance parameters can be changed from nano-second resolution to second resolution. Time stamp duplication can occur where different samples have a time stamp difference of zero and in such cases, the larger data value is preserved. At 306, network traffic is simulated. For example, network traffic can be simulated using Spirent for LTE4 data for 100,000 subscribers. At 308, the collectD and network traffic data are time synchronized and drop rates and KPIs correlated. Network traffic generated traffic and collectD data can be up-sampled to 1 second sampling interval. An overlap period can be computed based on the start and end dates (or times) of different parameters. At 310, certain parameters are removed from consideration. For example, KPIs that have constant values or zero values are identified and potentially not considered to infer packet drop activity. Removing constant values or zero values can reduce parameter features by approximately 35 to 40%.

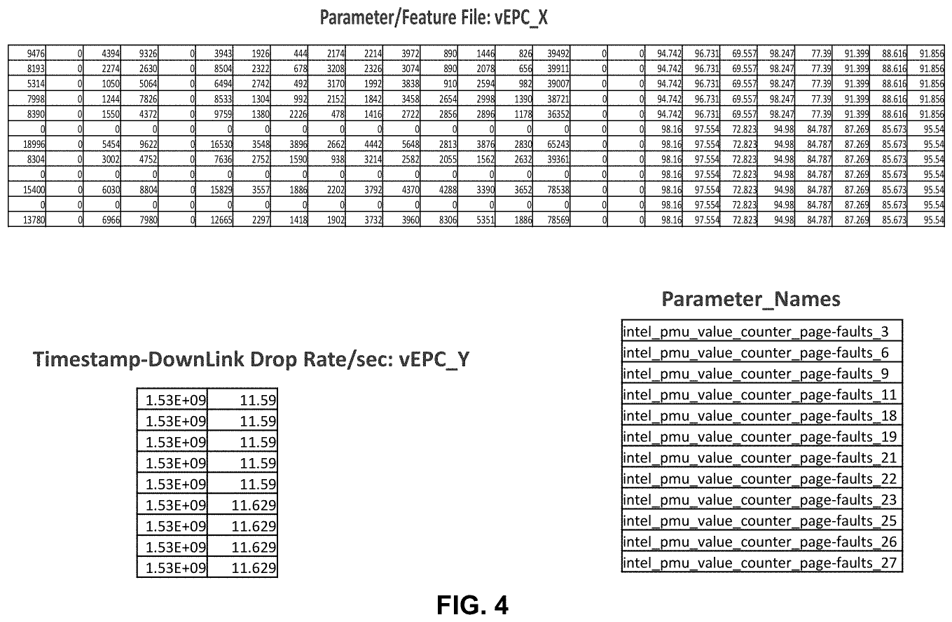

FIG. 4 presents preprocessed and synchronized system and network activity data. Pre-processed parameters from multiple files can be combined for building ML models. Synchronized data can be used to find the most correlated CPU parameters (e.g., from collectD) and train the machine learning model to detect packet drop based on the CPU parameters.

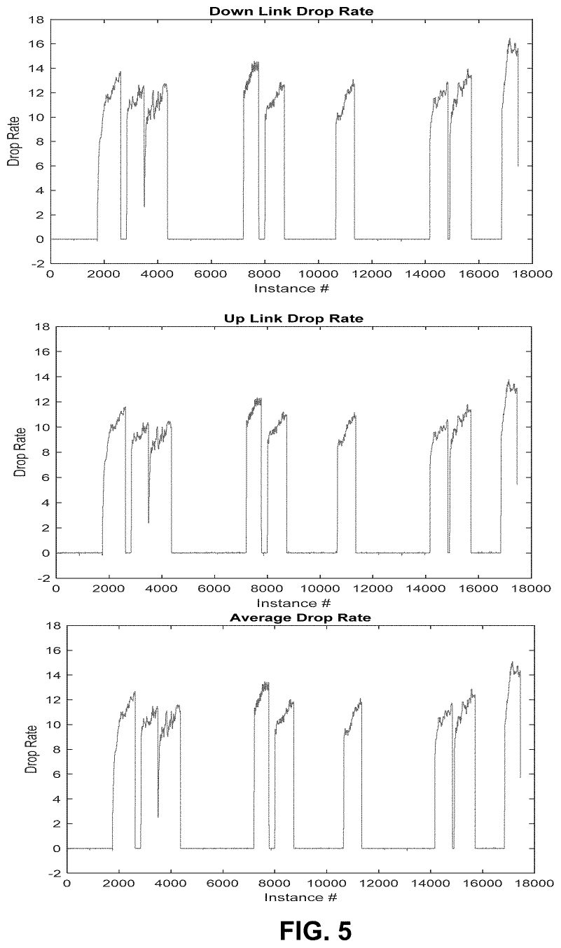

FIG. 5 shows the packet drop ground truth collected from a traffic generator. This packet drop data provided the ground truth for the ML models to train the ML model to predict packet drop occurrence. The data used to generate this figure includes 17460 instances combined from multiple test sessions with drop rates shown. A number of samples with packet loss is 6489 whereas a number of samples with no packet loss is 10971. There were 339 collectD parameters labeled with downlink/uplink/average packet drop rate per second. A drop rate of 2% was a threshold to binarize the data.

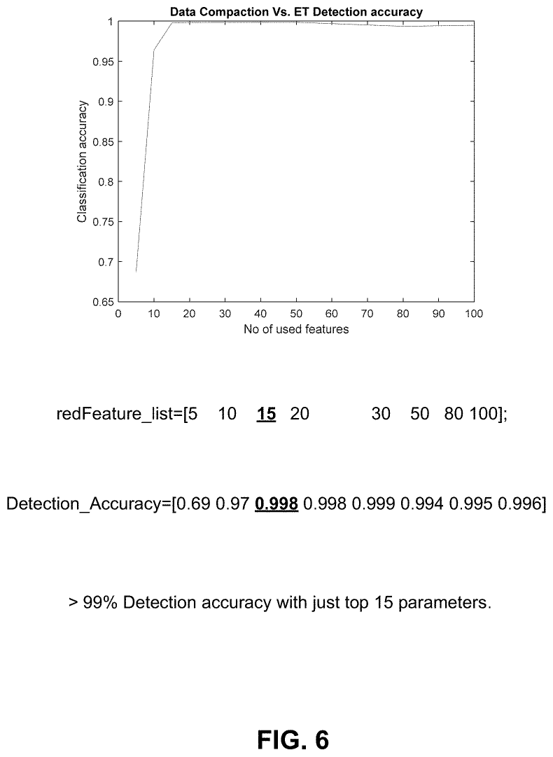

FIG. 6 presents example results of a trained ML inference model in predicting packet drop with different numbers of most correlated CPU parameters, sorted based on their extent of correlation. In some examples, with just 15 parameters, the packet drop detection accuracy goes up to ˜99%. Accordingly, a compact set of parameters can be the 15 parameters where saturation detection of accuracy occurs (leveling off) as compared to use of more parameters. In this example, accuracy is a measurement of actual packet drop as compared to predicted packet drop. If all predicted packet drops correlate to actual packet drops, accuracy would be 100%. Notably, after 50 parameters, the packet drop detection accuracy drops. In this example, 15-30 parameters can be used to train the ML model and for the ML model to infer packet drop. A number of parameters and parameters themselves can be chosen based on the least number of parameters for a peak accuracy value. In some examples, a number of parameters is chosen and parameters themselves can be chosen at a point before accuracy value decreases or remains flat with increasing number of parameters considered. Another consideration in determining a number of parameters or features to use is time to train an inference model or time for the inference model to generate a prediction. Consideration of larger numbers of parameters or features can lead to higher accuracy but longer training time and longer time to inference. For example, if inference time for an ML model can be reduced by 4 fold, by just reducing the number of parameters but with a threshold level of accuracy (e.g., 95%), then the lower number of parameters is chosen. Thereby, more time is given to allow an orchestrator to request and complete mitigating actions when SLA adherence is endangered.

A RELIEF method can be used for feature or parameter selection. Different numbers of top features (by weight) used for testing can be selected by: randomly sampled training versus test ratio being 7:3 at each fold or ExtraTrees method for classification (with drop rate threshold for binarizing=2). Accuracy is average of 10 fold cross-validation. For each fold, 70% data can be used for training and 30% for testing.

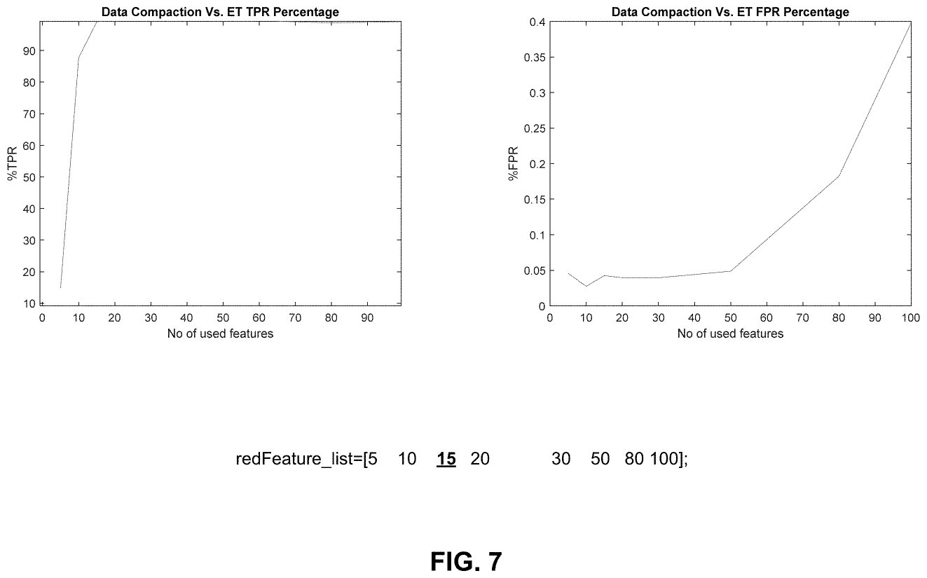

FIG. 7 shows a True Positive Rate (TPR) and False Positive Rate (FPR) with respect to the number of features used, ranked as per their correlation to packet drop. TPR and FPR can be measured with respect to packet drop and whether packet drop was actually correlated with certain variables. In this example, use of 15 or more parameters provides a relative TPR maxima (saturation) and 40 or fewer parameters provides a relative FPR minimum (saturation). Accordingly, a compact parameter set of approximately 15-40 parameters can be used to train an ML model to predict packet drops.

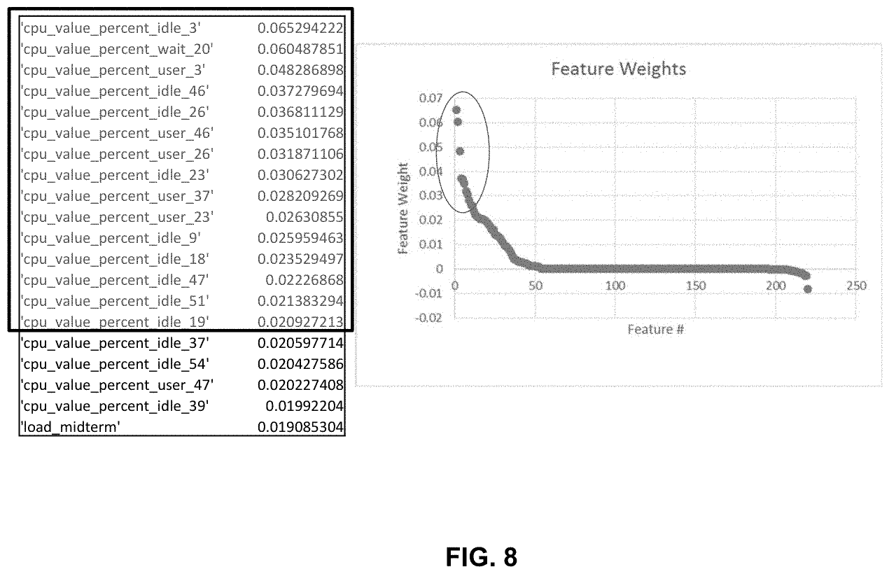

FIG. 8 shows an example of parameters used to predict downlink (DL) packet drop. A drop rate threshold of 2 was used. Parameter cpu_value_percent_idle_1 is an idleness indicator of core 1. Parameter cpu_value_percent_wait_m indicates that core m is idle waiting for an input/output operation to complete. Parameter cpu_value_percent_user_n indicates time spent by a core n on non-network interface related user space processes. In this example, parameters that are highly correlated with DL packet drop are cpu_value_percent_idle, cpu_value_percent_wait, and cpu_value_percent_user.

In this particular example, the following performance indicators or KPIs are used and specific value combinations of these performance indicators identify packet drop. In some examples, the KPIs values are to be equal to the specified values or at least or most the values listed below for packet drop to be predicted to occur.

| | |
|---|---|
| ‘cpu_value_percent_idle_3’ | 0.065294222 |
| ‘cpu_value_percent_wait_20’ | 0.060487851 |
| ‘cpu_value_percent_user_3’ | 0.048286898 |
| ‘cpu_value_percent_idle_46’ | 0.037279694 |
| ‘cpu_value_percent_idle_26’ | 0.036811129 |
| ‘cpu_value_percent_user_46’ | 0.035101768 |
| ‘cpu_value_percent_user_26’ | 0.031871106 |
| ‘cpu_value_percent_idle_23’ | 0.030627302 |
| ‘cpu_value_percent_user_37’ | 0.028209269 |
| ‘cpu_value_percent_user_23’ | 0.02630855 |
| ‘cpu_value_percent_idle_9’ | 0.025959463 |
| ‘cpu_value_percent_idle_18’ | 0.023529497 |
| ‘cpu_value_percent_idle_47’ | 0.02226868 |
| ‘cpu_value_percent_idle_51’ | 0.021383294 |
| ‘cpu_value_percent_idle_19’ | 0.020927213 |

In this example, cpu_value_percent_idle_3 indicates core number 3 has an idle indicator of 0.065294222. In other words, core #3 is idle 6.529% of an interval of time. Likewise, cpu_value_percent_idle_46 indicates an idleness indicator of core number 46.

An example correlation of CPU cores to functions is as follows. Cores 0-7 can run MCM-related process, cores 0-15 can run CSM-related processes, and cores 0-17 can run SSM-related processes. In this example, it is observed that parameters of cores 3, 23, 46, and 26 are related to packet drop and can be part of a compacted set of KPIs used to train an ML model to infer packet drop occurrences. Cores 46, 26 and 23 run MCM-related operations whereas cores 3 and 20 run CSM-related operations. Accordingly, ML model training and inference based on core parameters can be made based on MCM, CSM and SSM operations being executed by particular cores.

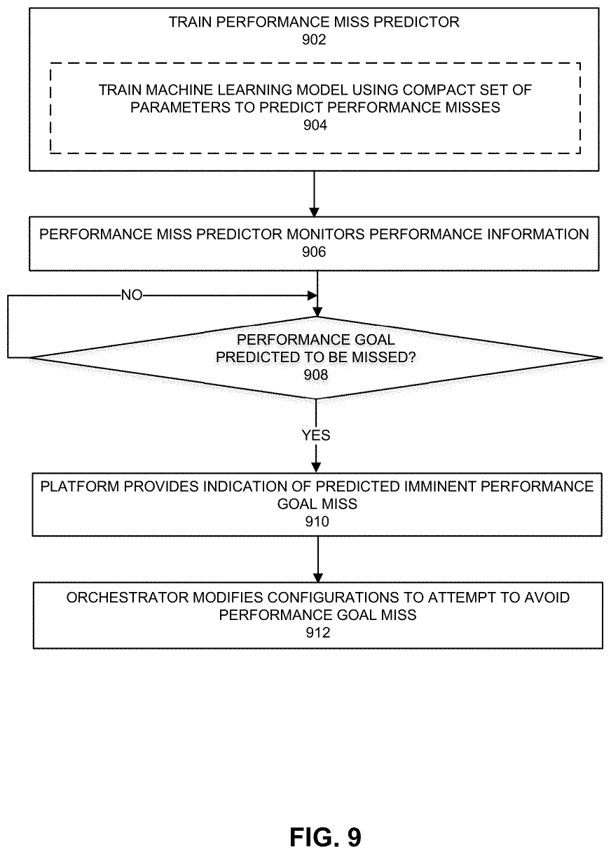

FIG. 9 depicts an example process. At 902, a performance miss predictor can be trained to identify correlations between operations with performance goals and a compact set of performance indicators. For example, the performance goals can relate to a maximum permitted downlink packet drop rate specified in an SLA. Numerous performance indicators of a computing platform can be measured. For example, collectD daemons can be executed on computing platforms to monitor CPU characteristics to determine KPI for a particular application workload. A compact set of performance indicators can be determined from a maximum or upper saturated True Positive Rate (TPR) and minimum or lower saturated False Positive Rate (FPR) relative to the measured performance goal. For example, a compact set of measured performance indicators can be selected based on a performance goal of a particular downlink packet drop rate such that a correlation between performance indicators and packet drop identification yields a maximum or upper saturated TPR and minimum or lower saturated FPR. A compact set of parameters can be the parameters where saturation detection of accuracy occurs (leveling off) as compared to use of more parameters.

At 904, a machine learning (ML) model can be trained to use the compact set of performance indicators to predict when a performance goal will be missed. For example, if a performance goal is a packet drop rate, then particular values of a compact set of performance indicators can identify when the packet drop rate is expected to occur. Training can involve use of a traffic simulator to simulate network traffic to and from a device or system under test as well as use of a network traffic processing simulator on the device or system under test. For example, Spirent traffic generator can be used to simulate traffic with 4G LTE user equipment and an Affirmed vEPC can be used to simulate network functions generally performed by a discrete hardware or a packet processing engine based on application activity and/or network traffic. After the ML model is trained to sufficiently accurately predict packet drop, the ML model can be used to infer when packet drops will occur based on measured performance indicators.

At 906, in a platform, the performance monitors are executed and performance miss predictor can be used to monitor a compact set of performance indicators. The platform can be a data center, rack, server, host computer, edge computing node, fog computing node, base station, and other systems.

At 908, a determination is made whether a performance goal will be missed based on inference by an ML model using the compact set of parameters. If a performance goal is identified to be missed, then the process continues to 910. If a performance goal is not identified to be missed, 908 can repeat.

At 910, the platform provides an indication of imminent performance goal miss to an orchestrator. For example, the platform can be connected to the orchestrator using a switch, interconnect, bus, fabric, or network. An indication of imminent performance goal miss can be encapsulated in a protocol specific communication and sent to the orchestrator. The indication can include one or more header fields from the packet(s) (e.g., a flow or a traffic class) that are expected to experience a drop rate that exceeds a permitted performance goal.

At 912, the orchestrator performs mitigation actions to attempt to avoid violation of a performance goal. For example, an SLA can specify maximum or minimum performance goals that are accepted. For the example of a packet drop exceeding a maximum permitted rate being imminent or expected, the orchestrator can modify a transmitter network device (e.g., source endpoint, router, switch) to adjust a transmit rate (e.g., lower) for packets associated with the identified drop rate or use a new path for the packets. Various packet header characteristics can be used to differentiate packets and adjust a transmit rate for packets that are likely to violate packet drop rate in applicable SLAs.

In addition, or alternatively, orchestrator can configure compute and memory resources in the platform to allocate more compute resources and/or buffer space for the one or more packets with characteristics identified as likely to be dropped at a rate that is not permitted in an applicable SLA. Increasing CPU power frequency or polling rate of received packets to process packets of a particular flow can potentially avoid or reduce packet drop. Applications or virtual execution environments running on a particular core can be migrated to another core to free computing resources to allow more computing resources to be allocated to processing packets. Prioritization of processing certain packets may be increased to reduce likelihood of packet drop. Allocating additional storage (buffer) for received packets can allow additional packets to be stored instead of being dropped.

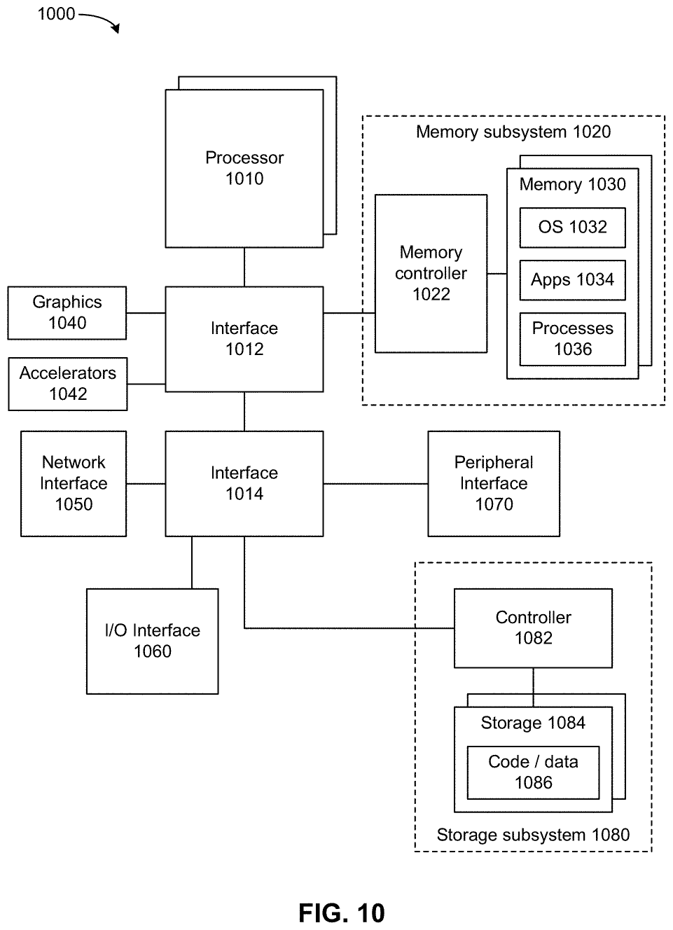

FIG. 10 depicts a system. The system can use embodiments described herein to predict possible SLA violation and to attempt to prevent SLA violation. System 1000 includes processor 1010, which provides processing, operation management, and execution of instructions for system 1000. Processor 1010 can include any type of microprocessor, central processing unit (CPU), graphics processing unit (GPU), processing core, or other processing hardware to provide processing for system 1000, or a combination of processors. Processor 1010 controls the overall operation of system 1000, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1000 includes interface 1012 coupled to processor 1010, which can represent a higher speed interface or a high throughput interface for system components that needs higher bandwidth connections, such as memory subsystem 1020 or graphics interface components 1040, or accelerators 1042. Interface 1012 represents an interface circuit, which can be a standalone component or integrated onto a processor die. Where present, graphics interface 440 interfaces to graphics components for providing a visual display to a user of system 1000. In one example, graphics interface 1040 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 1040 generates a display based on data stored in memory 1030 or based on operations executed by processor 1110 or both. In one example, graphics interface 1040 generates a display based on data stored in memory 1030 or based on operations executed by processor 1010 or both.

Accelerators 1042 can be a fixed function offload engine that can be accessed or used by a processor 1010. Accelerators 1042 can be coupled to processor 1010 using a memory interface (e.g., DDR4 and DDR5) or using any networking or connection standard described herein. For example, an accelerator among accelerators 1042 can provide sequential and speculative decoding operations in a manner described herein, compression (DC) capability, cryptography services such as public key encryption (PKE), cipher, hash/authentication capabilities, decryption, or other capabilities or services. In some embodiments, in addition or alternatively, an accelerator among accelerators 1042 provides field select controller capabilities as described herein. In some cases, accelerators 1042 can be integrated into a CPU socket (e.g., a connector to a motherboard or circuit board that includes a CPU and provides an electrical interface with the CPU). For example, accelerators 1042 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 1042 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 1020 represents the main memory of system 1000 and provides storage for code to be executed by processor 1010, or data values to be used in executing a routine. Memory subsystem 1020 can include one or more memory devices 1030 such as read-only memory (ROM), flash memory, one or more varieties of random access memory (RAM) such as DRAM, or other memory devices, or a combination of such devices. Memory 1030 stores and hosts, among other things, operating system (OS) 1032 to provide a software platform for execution of instructions in system 1000. Additionally, applications 1034 can execute on the software platform of OS 1032 from memory 1030. Applications 1034 represent programs that have their own operational logic to perform execution of one or more functions. Processes 1036 represent agents or routines that provide auxiliary functions to OS 1032 or one or more applications 1034 or a combination. OS 1032, applications 1034, and processes 1036 provide software logic to provide functions for system 1000. In one example, memory subsystem 1020 includes memory controller 1022, which is a memory controller to generate and issue commands to memory 1030. It will be understood that memory controller 1022 could be a physical part of processor 1010 or a physical part of interface 1012. For example, memory controller 1022 can be an integrated memory controller, integrated onto a circuit with processor 1010.

While not specifically illustrated, it will be understood that system 1000 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1000 includes interface 1014, which can be coupled to interface 1012. In one example, interface 1014 represents an interface circuit, which can include standalone components and integrated circuitry. In one example, multiple user interface components or peripheral components, or both, couple to interface 1014. Network interface 1050 provides system 1000 the ability to communicate with remote devices (e.g., servers or other computing devices) over one or more networks. Network interface 1050 can include an Ethernet adapter, wireless interconnection components, cellular network interconnection components, USB (universal serial bus), or other wired or wireless standards-based or proprietary interfaces. Network interface 1050 can transmit data to a device that is in the same data center or rack or a remote device, which can include sending data stored in memory. Network interface 1050 can receive data from a remote device, which can include storing received data into memory. Various embodiments can be used in connection with network interface 1050, processor 1010, and memory subsystem 1020.

In one example, system 1000 includes one or more input/output (I/O) interface(s) 1060. I/O interface 1060 can include one or more interface components through which a user interacts with system 1000 (e.g., audio, alphanumeric, tactile/touch, or other interfacing). Peripheral interface 1070 can include any hardware interface not specifically mentioned above. Peripherals refer generally to devices that connect dependently to system 1000. A dependent connection is one where system 1000 provides the software platform or hardware platform or both on which operation executes, and with which a user interacts.

In one example, system 1000 includes storage subsystem 1080 to store data in a nonvolatile manner. In one example, in certain system implementations, at least certain components of storage 1080 can overlap with components of memory subsystem 1020. Storage subsystem 1080 includes storage device(s) 1084, which can be or include any conventional medium for storing large amounts of data in a nonvolatile manner, such as one or more magnetic, solid state, or optical based disks, or a combination. Storage 1084 holds code or instructions and data 1046 in a persistent state (e.g., the value is retained despite interruption of power to system 1000). Storage 1084 can be generically considered to be a “memory,” although memory 1030 is typically the executing or operating memory to provide instructions to processor 1010. Whereas storage 1084 is nonvolatile, memory 1030 can include volatile memory (e.g., the value or state of the data is indeterminate if power is interrupted to system 1000). In one example, storage subsystem 1080 includes controller 1082 to interface with storage 1084. In one example controller 1082 is a physical part of interface 1014 or processor 1010 or can include circuits or logic in both processor 1010 and interface 1014.

A volatile memory is memory whose state (and therefore the data stored in it) is indeterminate if power is interrupted to the device. Dynamic volatile memory can involve refreshing the data stored in the device to maintain state. One example of dynamic volatile memory incudes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 1000. More specifically, power source typically interfaces to one or multiple power supplies in system 1000 to provide power to the components of system 1000. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 1000 can be implemented using interconnected compute sleds of processors, memories, storages, network interfaces, and other components. High speed interconnects between components can be used such as: Ethernet (IEEE 802.3), remote direct memory access (RDMA), InfiniBand, Internet Wide Area RDMA Protocol (iWARP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof. Data can be copied or stored to virtualized storage nodes using a protocol such as NVMe over Fabrics (NVMe-oF) or NVMe.

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

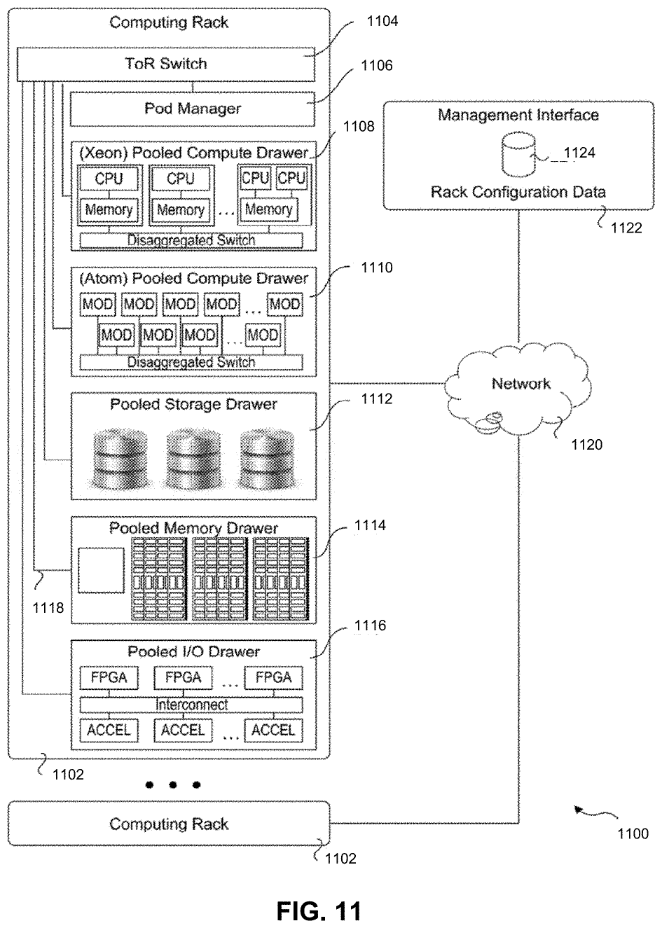

FIG. 11 depicts an environment 1100 includes multiple computing racks 1102, some including a Top of Rack (ToR) switch 1104, a pod manager 1106, and a plurality of pooled system drawers. Various embodiments can be used to predict imminent SLA violation and attempt to prevent SLA violation. Generally, the pooled system drawers may include pooled compute drawers and pooled storage drawers. Optionally, the pooled system drawers may also include pooled memory drawers and pooled Input/Output (I/O) drawers. In the illustrated embodiment the pooled system drawers include an Intel® XEON® pooled computer drawer 1108, and Intel® ATOM™ pooled compute drawer 1110, a pooled storage drawer 1112, a pooled memory drawer 1114, and a pooled I/O drawer 1116. Some of the pooled system drawers is connected to ToR switch 1104 via a high-speed link 1118, such as a 40 Gigabit/second (Gb/s) or 100 Gb/s Ethernet link or a 100+ Gb/s Silicon Photonics (SiPh) optical link. In one embodiment high-speed link 1118 comprises an 800 Gb/s SiPh optical link.

Multiple of the computing racks 1102 may be interconnected via their ToR switches 1104 (e.g., to a pod-level switch or data center switch), as illustrated by connections to a network 1120. In some embodiments, groups of computing racks 1102 are managed as separate pods via pod manager(s) 1106. In one embodiment, a single pod manager is used to manage racks in the pod. Alternatively, distributed pod managers may be used for pod management operations.

Environment 1100 further includes a management interface 1122 that is used to manage various aspects of the environment. This includes managing rack configuration, with corresponding parameters stored as rack configuration data 1124.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” “logic,” “circuit,” or “circuitry.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

Example 1 includes a computing platform that includes: a memory and at least one processor coupled to the memory, the at least one processor to indicate a prediction of a performance level failing to meet a performance goal independent from measurement of the performance level and based on performance monitoring of the at least one processor using a compact set of measurements.

Example 2 includes any example, wherein the compact set of measurements are selected based on detection accuracy using the compact set of measurements leveling off as compared to a detection accuracy level from use of more measurements and based on consideration of a time taken to predict performance level failing to meet a performance goal.

Example 3 includes any example, wherein the performance goal is based on a service level agreement (SLA).

Example 4 includes any example, wherein the performance monitoring is of core activity or inactivity.

Example 5 includes any example, wherein the at least one processor is to execute a trained machine learning (ML) model to infer performance goal failure based on performance monitoring of the at least one processor using a compact set of measurements.

Example 6 includes any example, wherein the ML model is trained using a simulation of traffic and wherein the compact set of measurements are selected during the training.

Example 7 includes any example, and including a processor to: initiate at least one mitigation action based on the indication of a prediction of performance goal failure to attempt to avoid violation of a performance goal.

Example 8 includes any example, wherein to initiate at least one mitigation action, the processor is to perform one or more of: cause migration of a workload to another core, cause reduction of a packet transmit rate, cause use of a new path for transmitted packets, cause increase in central processing unit (CPU) power frequency, or cause increase in buffer space allocated to received packets.

Example 9 includes any example, wherein at least one processor is to: perform performance monitoring of one or more of: website hosting and serving, video streaming, database queries and lookup, or packet processing.

Example 10 includes any example, wherein performance monitoring of the at least one processor comprises execution of a collectD daemon.

Example 11 includes any example, wherein at least one processor is to: update a machine learning (ML) inference model based on indication of actual packet drops.

Example 12 includes any example, further including one or more of: a network interface, storage, rack, server, or data center.

Example 13 includes a computer-implemented method comprising: indicating that a performance level is predicted to not meet one or more associated performance goals independent from measurement of the performance level and based on occurrences of particular measurements of other performance indicators.

Example 14 includes any example, wherein the performance level comprises a packet drop rate and wherein the one or more associated performance goals comprise part of service level agreement (SLA) requirements that specify a packet drop rate threshold that violates the SLA.

Example 15 includes any example, wherein the performance indicators comprise one or more of: core idle measurement, core execution of user space processes, or core waiting for an input/output operation to complete.

Example 16 includes any example, wherein the occurrences of particular measurements of other performance indicators comprise performance measurements of at least one core.

Example 17 includes any example, wherein the indicating that a performance level is predicted to not meet one or more associated performance goals independent from measurement of the performance level and based on occurrences of particular measurements of other performance indicators comprises applying a machine learning (ML) model to infer computing performance will not meet one or more associated service level agreement (SLA) requirements based on occurrences of particular measurements of performance indicators.

Example 18 includes a system comprising: at least one memory device; at least one network interface; and at least one processor communicatively coupled to the at least one memory device and the at least one network interface, wherein the at least one processor is to: receive measurements of performance indicators and indicate when a performance level will not meet one or more associated performance goals independent from measurement of the performance level and based on occurrences of particular measurements of the performance indicators.

Example 19 includes any example, wherein the measurements of performance indicators comprise at least one core activity or inactivity measurement.

Example 20 includes any example, wherein the performance level comprises packet drop rate of packets received at the at least one network interface.

Example 21 includes any example, wherein based on an indication a performance level will not meet one or more associated performance goals, the at least one processor is to attempt to avoid the performance not meeting one or more associated service level agreement (SLA) requirement and perform one or more of: migrate a workload to another core, reduce a packet transmit rate, apply a new path for transmitted packets, increase central processing unit (CPU) power frequency, or increase buffer space allocated to received packets.

What is claimed is:

1. A computing platform that comprises:
a memory and
at least one processor coupled to the memory, the at least one processor to indicate a prediction of a performance level failing to meet a performance goal independent from measurement of the performance level and based on performance monitoring of the at least one processor using a compact set of measurements.

2. The computing platform of claim 1, wherein the compact set of measurements are selected based on detection accuracy using the compact set of measurements leveling off as compared to a detection accuracy level from use of more measurements and based on consideration of a time taken to predict performance level failing to meet a performance goal.

3. The computing platform of claim 1, wherein the performance goal is based on a service level agreement (SLA).

4. The computing platform of claim 1, wherein the performance monitoring is of core activity or inactivity.

5. The computing platform of claim 1, wherein the at least one processor is to execute a trained machine learning (ML) model to infer performance goal failure based on performance monitoring of the at least one processor using a compact set of measurements.

6. The computing platform of claim 5, wherein the ML model is trained using a simulation of traffic and wherein the compact set of measurements are selected during the training.

7. The computing platform of claim 1, comprising a processor to:
initiate at least one mitigation action based on the indication of a prediction of performance goal failure to attempt to avoid violation of a performance goal.

8. The computing platform of claim 7, wherein to initiate at least one mitigation action, the processor is to perform one or more of: cause migration of a workload to another core, cause reduction of a packet transmit rate, cause use of a new path for transmitted packets, cause increase in central processing unit (CPU) power frequency, or cause increase in buffer space allocated to received packets.

9. The computing platform of claim 1, wherein at least one processor is to:
perform performance monitoring of one or more of: website hosting and serving, video streaming, database queries and lookup, or packet processing.

10. The computing platform of claim 1, wherein performance monitoring of the at least one processor comprises execution of a collectD daemon.

11. The computing platform of claim 1, wherein at least one processor is to:
update a machine learning (ML) inference model based on indication of actual packet drops.

12. The computing platform of claim 1, further comprising one or more of: a network interface, storage, rack, server, or data center.

13. A computer-implemented method comprising:
indicating that a performance level is predicted to not meet one or more associated performance goals independent from measurement of the performance level and based on occurrences of particular measurements of other performance indicators.

14. The method of claim 13, wherein the performance level comprises a packet drop rate and wherein the one or more associated performance goals comprise part of service level agreement (SLA) requirements that specify a packet drop rate threshold that violates the SLA.

15. The method of claim 13, wherein the performance indicators comprise one or more of: core idle measurement, core execution of user space processes, or core waiting for an input/output operation to complete.

16. The method of claim 13, wherein the occurrences of particular measurements of other performance indicators comprise performance measurements of at least one core.

17. The method of claim 13, wherein the indicating that a performance level is predicted to not meet one or more associated performance goals independent from measurement of the performance level and based on occurrences of particular measurements of other performance indicators comprises applying a machine learning (ML) model to infer computing performance will not meet one or more associated service level agreement (SLA) requirements based on occurrences of particular measurements of performance indicators.

18. A system comprising:
at least one memory device;
at least one network interface; and
at least one processor communicatively coupled to the at least one memory device and the at least one network interface, wherein the at least one processor is to:
receive measurements of performance indicators and
indicate when a performance level will not meet one or more associated performance goals independent from measurement of the performance level and based on occurrences of particular measurements of the performance indicators.

19. The system of claim 18, wherein the measurements of performance indicators comprise at least one core activity or inactivity measurement.

20. The system of claim 18, wherein the performance level comprises packet drop rate of packets received at the at least one network interface.

21. The system of claim 18, wherein based on an indication a performance level will not meet one or more associated performance goals, the at least one processor is to attempt to avoid the performance not meeting one or more associated service level agreement (SLA) requirement and perform one or more of: migrate a workload to another core, reduce a packet transmit rate, apply a new path for transmitted packets, increase central processing unit (CPU) power frequency, or increase buffer space allocated to received packets.
